(19) United States
(12) Patent Application Publication
(10) Pub. No.: US 2023/0304518 A1
(43) Pub. Date: Sep. 28, 2023

(54) MOUNTING STRUCTURE OF RESIN MEMBER

(71) Applicant: Isuzu Motors Limited, Yokohama-shi (JP)

(72) Inventors: Masaya TOKUTAKE, Fujisawa-shi (JP); Naoki MORI, Fujisawa-shi (JP)

(73) Assignee: Isuzu Motors Limited, Yokohama-shi (JP)

(21) Appl. No.: 18/124,637

(22) Filed: Mar. 22, 2023

(30) Foreign Application Priority Data
Mar. 23, 2022 (JP) 2022-047476

(51) Int. Cl. F16B 5/02; F16B 43/00

(52) U.S. Cl. CPC F16B 5/02; F16B 43/00; F16B 2200/403

(57) ABSTRACT

In a mounting structure of a resin member, a collar has an outside diameter smaller than the diameter of a collar insertion hole of a resin-made fixation portion, and the collar defines a collar hole therein. A washer member defines a washer hole therein. The washer member has an outside diameter greater than the diameter of the collar insertion hole and an inside diameter smaller than the outside diameter of the collar. A holding portion throughhole of a metal-made holding portion, the collar hole, and the washer hole form a bolt insertion hole through which a bolt shaft is inserted in a state in which the collar is inserted in the collar insertion hole, the metal-made holding portion is laid on or over one surface of the resin-made fixation portion, and the washer member is laid on or over the other surface of the resin-made fixation portion.

### CROSS REFERENCE TO RELATED APPLICATIONS

This application claims the benefit of priority of Japanese Patent Application No. 2022-047476, filed on Mar. 23, 2022, the contents of which are incorporated by reference as if fully set forth herein in their entirety.

### TECHNICAL FIELD

The present disclosure relates to a mounting structure of a resin member.

### BACKGROUND ART

PTL 1 describes a structure of fastening a resin cover and a metallic housing to each other using shoulder bolts. Each shoulder bolt includes a thread portion on one side thereof and a head on the other side. The shoulder bolt also includes a large-diameter shank between the thread portion and the head. In the shoulder bolt, the outside diameter of the head is the largest, the outside diameter of the large-diameter shank is the next largest, and the outside diameter of the thread portion is the smallest. A throughhole through which the large-diameter shank of the shoulder bolt can be inserted is formed in the resin cover, and a threaded hole into which the thread portion can be screwed is formed in the metallic housing. The thickness of the resin cover is smaller than the length of the large-diameter shank in the axial direction.

### CITATION LIST

### Patent Literature

PTL 1
   Japanese Patent Application Laid-Open No. 2021-80995

### SUMMARY OF INVENTION

### Technical Problem

In the case where a metal plate is fixed to a resin plate by screwing a nut on a shoulder bolt like the one described in PTL 1, a large-diameter bolt insertion hole through which the large-diameter shank of the shoulder bolt is inserted is formed in the resin plate, and a small-diameter bolt insertion hole through which the thread portion is inserted is formed in the metal plate. The length of the large-diameter shank is set to be greater than the thickness of the resin plate. The large-diameter shank is inserted through the bolt insertion hole of the resin plate, and the thread portion is inserted through the bolt insertion hole of the metal plate. The nut is screwed on the thread portion. Accordingly, the bolt and nut do not fasten the resin plate directly, and the fastening force of the bolt and nut is applied to the metal plate and the large-diameter shank of the shoulder bolt. As a result, the fastening force is transmitted only minimally to the resin plate, which can reduce deformation and crack generation of the resin plate.

In the mounting of the resin plate using the shoulder bolt, however, the length of the large-diameter shank needs to meet the thickness of an individual resin plate, which requires a special shoulder bolt for a dedicated use and inevitably increases the cost of component. When multiple types of resin plates having different thicknesses need to be mounted, the number of the types of shoulder bolts increases, which complicates the component management. In the case where the shoulder bolt breaks when in use and a user replaces it with a new one, the user needs to obtain a special shoulder bolt. The special shoulder bolt is difficult to obtain than a general purpose shoulder bolt, which may pose an obstacle in replacement. Moreover, the insertion direction of the shoulder bolt is only from the side of the resin plate. Surrounding conditions may prevent the shoulder bolt from being inserted from the side of the resin plate. In such a case, the resin plate cannot be mounted using the shoulder bolt.

Accordingly, an object of the present disclosure is to provide a mounting structure of a resin member with which the resin member can be mounted by fastening a general purpose bolt and a general purpose nut together and that can reduce deformation and crack generation of the resin member caused by a fastening force.

### Solution to Problem

According to a first aspect of the present disclosure, a mounting structure of a resin member in which a flat resin-made fixation portion of the resin member is laid on or over and fixed to a flat metal-made holding portion is provided. The mounting structure includes a holding portion throughhole, a circular collar insertion hole, a cylindrical or circular collar, a circular washer member, a bolt, and a nut.

The holding portion throughhole is pierced through the metal-made holding portion. The collar insertion hole is pierced through the resin-made fixation portion and has an inside diameter greater than a diameter of the holding portion throughhole. The collar has an outside diameter smaller than the diameter of the collar insertion hole and defines a collar hole therein. The washer member defines a washer hole therein and has an outside diameter greater than the diameter of the collar insertion hole and an inside diameter smaller than the outside diameter of the collar.

The length of the collar in the direction orthogonal to radial directions of the collar is greater than a thickness of the resin-made fixation portion. The holding portion throughhole, the collar hole, and the washer hole form a bolt insertion hole through which a bolt shaft of the bolt is inserted in a state in which the collar is inserted in the collar insertion hole, one surface of the resin-made fixation portion is laid on or over the metal-made holding portion, and the washer member is laid on or over another surface of the resin-made fixation portion. The nut is screwed on the bolt shaft inserted in the bolt insertion hole.

According to the above configuration, when the resin member is fixed to the metal-made holding portion, the collar is first inserted in the collar insertion hole. Subsequently, the metal-made holding portion is laid on or over the one surface of the resin-made fixation portion and the washer member is laid on or over the other surface of the resin-made fixation portion in such a manner that the holding portion throughhole, the collar hole, and the washer hole form the bolt insertion hole. The bolt shaft is inserted through the bolt insertion hole, and the nut is screwed tightly on the bolt shaft.

The length of the collar in the direction orthogonal to the radial directions thereof is greater than the thickness of the resin-made fixation portion. As a result, the bolt and nut do not directly fasten the resin-made fixation portion to the metal-made holding portion. Instead, the fastening force by the bolt and nut is applied to the metal-made holding portion, the collar, and the washer member. Accordingly, the fastening force is transmitted only minimally to the resin-made fixation portion, which can reduce deformation or crack generation of the resin-made fixation portion.

The outside diameter of the washer member is greater than the diameter of the collar insertion hole. Accordingly, even in the case where the bolt head or the nut that comes into contact with the washer member does not have a sufficiently large diameter relative to the collar insertion hole, the washer member reliably prevents the resin-made fixation portion from coming off the metal-made holding portion.

A general purpose bolt can be used as the bolt, which can suppress an increase in the cost of component and also suppress an increase in the number of the types of bolts to be used, leading to easy component management. Even if the bolt breaks when in use, a user can obtain the bolt easily and replace it with a new one. The bolt can be inserted from the side of the resin-made fixation portion or from the side of the metal-made holding portion. Accordingly, the insertion of the bolt is less affected by the surrounding conditions.

Both the resin-made fixation portion and the bolt shaft can rotate relative to the collar, which can reduce the likelihood of the resin member and the bolt turning together when the bolt is tightened, which can improve the workability in tightening the bolt. In addition, the washer member is shaped annularly. When the thickness of the washer member is set to be smaller than the outside diameter thereof, a general purpose flat washer can be used as the washer member.

According to a second aspect of the present disclosure, in the mounting structure of a resin member, according to the first aspect the collar has an annular shape in which the length of the collar is smaller than the outside diameter of the collar.

The collar has an annular shape of which the length (thickness) is smaller than the outside diameter thereof, which enables a general purpose flat washer (a flat washer having an outside diameter greater than that of the washer member) to be used as the collar.

### Advantageous Effects of Invention

According to the present disclosure, the resin member can be mounted by fastening the general purpose bolt and the general purpose nut together, and the deformation and crack generation of the resin member caused by a fastening force can be reduced.

### BRIEF DESCRIPTION OF DRAWINGS

FIG. 1 is a side view schematically illustrating a mounting structure of a noise cover according to an embodiment of the present invention;

FIG. 2 is a cross-sectional view of the mounting structure taken along line II-II in FIG. 1;

FIG. 3 is an enlarged view illustrating part of the mounting structure of FIG. 2;

FIG. 4A is a front view illustrating a collar; and

FIG. 4B is a side view illustrating the collar.

### DESCRIPTION OF EMBODIMENTS

An embodiment of the present invention will be described with reference to the drawings. Note that in the following description, the “front-rear direction” is defined as the front-rear direction of a vehicle and the “right-left direction” is defined as the right-left direction of the vehicle when the vehicle faces frontward. Directions for each member in the following description are also defined with respect to the vehicle when the member is mounted on the vehicle.

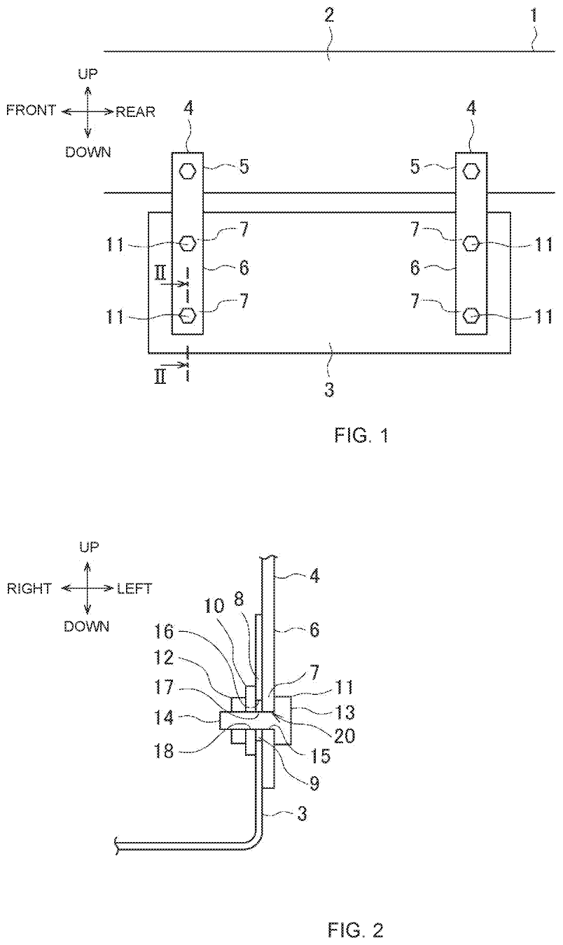

As illustrated in FIG. 1, body frame 1 of a vehicle includes right and left side frames 2 (illustration of the right side frame is omitted) and multiple cross frames (not illustrated). Right and left side frames 2 extend in the front-rear direction of the vehicle at both ends of the vehicle in the vehicle width direction. The cross frames extend in the vehicle width direction and connect right and left side frames 2 to each other.

A sound source (not illustrated) that emits noises is disposed between right and left side frames 2. Examples of the sound source include an engine, a motor, a transmission, an exhaust pipe, and the sound source is held by supporting members (not illustrated) and thereby fixed to body frame 1.

Right and left resin-made noise covers (resin members) 3 are fixed respectively to right and left side frames 2 using metal-made brackets 4. Noise covers 3 at least cover outward-facing sides of the sound source in the vehicle width direction and thereby attenuate the noise emitted from the sound source. Each of right and left brackets 4 is a belt-like plate of which the length in the up-down direction is longer than the length in the front-rear direction. Brackets 4 are disposed on noise cover 3 at multiple positions spaced in the front-rear direction of the vehicle (two positions in the present embodiment). Note that noise covers 3 and brackets 4 are provided symmetrically on the right and left sides of the vehicle. Accordingly, the following description will focus on noise cover 3 and brackets 4 on the left side, and descriptions of those on the right side will be omitted.

Each bracket 4 includes upper portion 5 and lower portion 6. Upper portion 5 of bracket 4 is laid on, and fixed to, side frame 2 from the outside in the vehicle width direction. Lower portion 6 of bracket 4 extends downward from upper portion 5. Lower portion 6 of bracket 4 includes multiple bracket-side holding portions (metal-made holding portions) 7. Bracket-side holding portions 7 are shaped tabularly and located at multiple positions (two positions in the present embodiment) that are spaced in the up-down direction. Noise cover 3 includes multiple cover-side fixation portions (resin-made fixation portions) 8. Cover-side fixation portions 8 are shaped tabularly and located at multiple positions (the same number of positions as that of bracket-side holding portion 7). Cover-side fixation portions 8 are laid on, and fixed to, respective bracket-side holding portions 7.

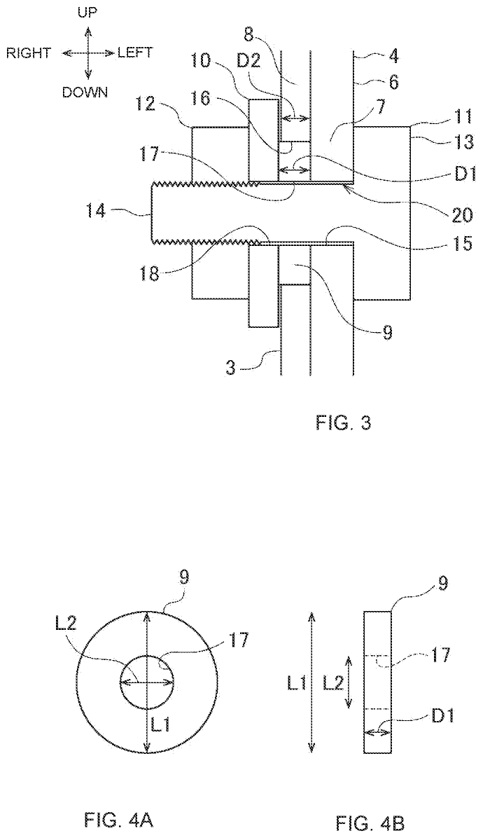

As illustrated FIGS. 2 and 3, each cover-side fixation portion 8 is fixed to corresponding bracket-side holding portion 7 using a metallic collar 9, metallic washer member 10, bolt 11, and nut 12.

Bolt 11 includes bolt head 13 and bolt shaft (thread portion) 14 extending from bolt head 13. Bolt head 13 and bolt shaft 14 are formed integrally, and nut 12 is screwed on bolt shaft 14.

Circular bracket throughhole (holding portion throughhole) 15 is formed through bracket-side holding portion 7 in the vehicle width direction. The diameter of bracket throughhole 15 is slightly larger than the outside diameter of bolt shaft 14.

Circular cover throughhole (collar insertion hole) 16 is formed through cover-side fixation portion 8 in the vehicle width direction. Cover throughhole 16 has a diameter (inside diameter) larger than that of bracket throughhole 15.

Collar 9 is shaped cylindrically or annularly and defines collar hole 17 therein. In the present embodiment, collar 9 is shaped like an annular disk (thin annular plate) of which thickness D1 of collar 9 (the length of collar 9 in the direction orthogonal to the radial directions thereof) is smaller than outside diameter L1 of collar 9 (see FIG. 4). Thickness D1 of collar 9 is slightly greater than thickness D2 of cover-side fixation portion 8 (for example, by 0.1 mm to about several tenths of millimeter).

Outside diameter L1 of collar 9 is slightly smaller than the diameter of cover throughhole 16, and the inside diameter L2 of collar 9 (i.e., the diameter of collar hole 17) is slightly greater than the outside diameter of bolt shaft 14. Collar 9 is inserted in cover throughhole 16 in such a manner that the central axis of collar 9 is substantially aligned with the central axis of cover throughhole 16.

Washer member 10 is shaped like an annular disk (thin annular plate) of which the thickness (the length of washer member 10 in the direction orthogonal to the radial directions thereof) is smaller than the outside diameter of washer member 10. The washer member defines washer hole 18 therein. The outside diameter of washer member 10 is greater than the diameter of cover throughhole 16, and the inside diameter of washer member 10 (i.e., the diameter of washer hole 18) is smaller than the outside diameter of collar 9.

Bracket throughhole 15, collar hole 17, and washer hole 18 form bolt insertion hole into which bolt shaft 14 is inserted in the state in which collar 9 is inserted in cover throughhole 16, the outer surface (one surface) of cover-side fixation portion 8 facing outward in the vehicle width direction is laid on the inner surface of bracket-side holding portion 7 facing inward in the vehicle width direction, and the outer surface of washer member 10 facing outward in the vehicle width direction is laid on or over the inner surface (the other surface) of cover-side fixation portion 8 facing inward in the vehicle width direction. Nut 12 is screwed on bolt shaft 14 inserted in bolt insertion hole 20.

When noise cover 3 is mounted on bracket 4, collar 9 is first inserted in cover throughhole 16 of cover-side fixation portion 8. Next, bracket-side holding portion 7 is laid on the surface of cover-side fixation portion 8 facing outward in the vehicle width direction and washer member 10 is laid on the surface of cover-side fixation portion 8 facing inward in the vehicle width direction in such a manner that bracket throughhole 15, collar hole 17, and washer hole 18 form bolt insertion hole 20. Bolt shaft 14 is subsequently inserted into bolt insertion hole 20, and nut 12 is screwed tightly on bolt shaft 14. Note that another washer may be present between bolt head 13 and bracket-side holding portion 7. In the illustrated example, bolt 11 is inserted from the outside in the vehicle width direction (from outside of bracket 4), and nut 12 comes into contact with washer member 10. The bolt 11, however, may be inserted from the inside in the vehicle width direction (from inside of noise cover 3), and bolt head 13 may come into contact with washer member 10.

According to the present embodiment, thickness D1 of collar 9 is greater than thickness D2 of cover-side fixation portion 8. As a result, bolt 11 and nut 12 do not directly fasten cover-side fixation portion 8 to bracket-side holding portion 7. Instead, the fastening force by bolt 11 and nut 12 is applied to bracket-side holding portion 7, washer member 10, and collar 9. Accordingly, the fastening force is transmitted only minimally to cover-side fixation portion 8, which can reduce deformation or crack generation of cover-side fixation portion 8.

The outside diameter of washer member 10 is greater than the diameter of cover throughhole 16. Accordingly, even in the case of nut 12 not having a sufficiently large diameter relative to cover throughhole 16, washer member 10 reliably prevents cover-side fixation portion 8 from coming off bracket-side holding portion 7.

A general purpose bolt can be used as bolt 11, which suppresses an increase in the cost of component and also suppresses an increase in the number of the types of bolt 11, leading to easy component management. Even if bolt 11 breaks when in use, a user can obtain bolt 11 easily and replace it with a new one. Bolt 11 can be inserted from the side of cover-side fixation portion 8 or from the side of bracket-side holding portion 7. Accordingly, the insertion of the bolt is less affected by the surrounding conditions.

Both cover-side fixation portion 8 and bolt shaft 14 can rotate relative to collar 9, which can reduce the likelihood of noise cover 3 and bolt 11 turning together when bolt 11 is tightened, which can improve workability in tightening the bolt. Washer member 10 is shaped like the annular disk (thin annular plate). Accordingly, a general purpose flat washer can be used as washer member 10. Collar 9 is shaped like the annular disk (thin annular plate). Accordingly, a general purpose flat washer (a flat washer having an outside diameter smaller than that of washer member 10) can be used as collar 9.

The present invention has been described with reference to the embodiment. The present invention, however, is not limited to the description of the above embodiment but can be modified in various ways without departing from the scope of the invention. In other words, other embodiments, examples, applications, and the like done by those skilled in the art on the basis of the above embodiment are to be included in the present invention.

For example, the structure of mounting resin-made noise cover 3 onto the metal-made bracket 4 is described in the present embodiment, but the combination of the metal-made member and the resin-made member is not limited to this. The present invention can be applied to combinations of various other members.

### INDUSTRIAL APPLICABILITY

The present invention can be widely applied to mounting structures of a resin member in which a flat resin-made fixation portion of the resin member is laid on and fixed to a flat metal-made holding portion.

1. A mounting structure of a resin member in which a flat resin-made fixation portion of the resin member is laid on or over and fixed to a flat metal-made holding portion, the mounting structure comprising:
a holding portion throughhole pierced through the metal-made holding portion;
a circular collar insertion hole pierced through the resin-made fixation portion and having an inside diameter greater than a diameter of the holding portion throughhole;
a collar having an outside diameter smaller than the diameter of the collar insertion hole and having a cylindrical or annular shape that defines a collar hole therein;
an annular washer member defining a washer hole therein and having an outside diameter greater than the diameter of the collar insertion hole and an inside diameter smaller than the outside diameter of the collar; and
a bolt and a nut, wherein
a length of the collar in a direction orthogonal to radial directions of the collar is greater than a thickness of the resin-made fixation portion,
the holding portion throughhole, the collar hole, and the washer hole form a bolt insertion hole through which a bolt shaft of the bolt is inserted in a state in which the collar is inserted in the collar insertion hole, one surface of the resin-made fixation portion is laid on or over the metal-made holding portion, and the washer member is laid on or over another surface of the resin-made fixation portion, and
the nut is screw-fitted on the bolt shaft inserted in the bolt insertion hole.

2. The mounting structure according to claim 1, wherein
the collar has an annular shape in which the length of the collar is smaller than the outside diameter of the collar.
